(19) United States
(12) Patent Application Publication
(10) Pub. No.: US 2008/0102744 A1
(43) Pub. Date: May 1, 2008

(54) Ventilation system

(75) Inventors: Carl Moore, Macedonia, OH (US); Chad J. Bradley, Sagamore Hills, OH (US); Timothy P. Chapin, Macedonia, OH (US); Chuck Vinci, Sheffield Village, OH (US)

Correspondence Address: FAY SHARPE LLP, 1100 SUPERIOR AVENUE, SEVENTH FLOOR, CLEVELAND, OH, 44114, US

(73) Assignee: Everdry Marketing & Management, Inc.

(21) Appl. No.: 11/899,175

(22) Filed: Sep. 5, 2007

Related U.S. Application Data
(60) Provisional application No. 60/855,677, filed on Oct. 31, 2006.

(51) Int. Cl. F24F 11/04; B01D 53/04; F24F 7/007; F25D 23/10

(52) U.S. Cl. 454/239; 454/249; 62/271; 96/143

(57) ABSTRACT

The present disclosure relates to a ventilation system for a building including a conditioning unit, a ventilation unit and a control unit. The conditioning unit is mounted in at least one of a door and a wall of the building for conditioning air as it moves through or into the building. The conditioning unit includes at least one air inlet and an air outlet, spaced from the air inlet. The at least one air inlet communicates with at least one of air within the building and atmosphere and the air outlet communicates with air within the building. The ventilation unit is spaced from and communicates with the conditioning unit for expelling air from the building to atmosphere. The ventilation unit includes an air inlet and an exhaust air outlet, spaced from the air inlet. The air inlet communicates with air within the building and the exhaust air outlet communicates with atmosphere. The control unit communicates with both the conditioning unit and the ventilation unit for actuating the conditioning unit when the ventilation unit is actuated, in order to regulate a rate of air flow through the conditioning unit.

### CROSS REFERENCE TO RELATED APPLICATIONS

This application claims priority from U.S. Provisional Patent Application Ser. No. 60/855,677, filed Oct. 31, 2006, and is incorporated herein by reference.

### BACKGROUND

The present disclosure generally relates to ventilation systems for controlling air quality in an enclosed space of a building.

Indoor air quality is generally affected by humidity, which is vaporized water in air. Relative humidity is the percentage of water vapor in air at a specific temperature, compared to the maximum amount of water vapor the air is capable of holding at that temperature. Disadvantages of high humidity in a building include the growth of mold, more noticeable odors (a musty smell) and staining, when condensation occurs on walls and floors. In addition, high humidity levels are not only uncomfortable but can also increase health risks. Thus, reduction of humidity levels is not only a comfort concern but also a health concern. To overcome these problems, ventilation systems have been developed for conditioning air in an enclosed space of a building. Homeowners can reduce their exposure to harmful bacteria, mold and mildew via air ventilation systems by regulating the humidity level within their homes. Homeowners also are becoming more aware of the importance of including air ventilation systems within their homes.

Construction of residential, as well as commercial, spaces influences how much humidity is desirable. Current building specifications call for the so-called super insulating of homes and other buildings for energy efficiency. However, these tightly constructed buildings with properly installed vapor barriers and tight fitting doors and windows generally have inadequate airflow. It is generally recommended that buildings have fifteen (15) cubic feet of airflow per person per hour and/or point thirty-five (0.35) air changes within the building per hour. Such insulated new home construction prevents the escape of heated, stale inside air and its subsequent replacement with cool outside air. Thus, more heat and moisture is retained in the building. The tight sealing also can lead to elevated indoor pollutant levels.

Air ventilation and dehumidifying systems have been used to regulate indoor air quality to provide greater comfort. Many dehumidifiers rely on refrigerated cooling coils and compression elements to dehumidify an enclosed space. Refrigerating coils increase the complexity and expense of the units, as well as the input energy necessary to operate the system. Dehumidification can be achieved with less expense by using desiccant materials. Desiccant materials can either adsorb or absorb moisture and then expel that moisture without the need for cooling coils. Desiccant dehumidifiers of the prior art typically use desiccants in the shape of a wheel. Such a configuration requires a motor to rotate the wheel, adding expense, complexity, and maintenance costs to the system.

Air ventilation and exchange systems have also been used to regulate indoor air quality to provide greater comfort. Such systems bring fresh cool air into the conditioned space to replace stale heated air in the space. However, the conventional air exchange system typically uses an existing furnace as the means to recirculate air in the building, which adds maintenance costs to the system.

Accordingly, it is desirable to develop a new and improved ventilation system which would overcome the foregoing deficiencies and others while meeting the above-stated needs and providing better and more advantageous overall results.

### BRIEF DESCRIPTION

In accordance with one aspect of the present disclosure, a ventilation system for a building includes a conditioning unit, a ventilation unit and a control unit. The conditioning unit is mounted in at least one of a door and a wall of the building for conditioning air as it moves through or into the building. The conditioning unit includes a fan and at least one air inlet and an air outlet, spaced from the air inlet. The at least one air inlet communicates with at least one of air within the building and atmosphere and the air outlet communicates with air within the building. The ventilation unit is spaced from and communicates with the conditioning unit for expelling air from the building to atmosphere. The ventilation unit includes an air inlet and an exhaust air outlet, spaced from the air inlet. The air inlet communicates with air within the building and the exhaust air outlet communicates with atmosphere. The control unit communicates with both the conditioning unit and the ventilation unit for actuating the conditioning unit when the ventilation unit is actuated, in order to regulate a rate of air flow through the conditioning unit.

In accordance with another aspect of the present disclosure, a ventilation and dehumidifying system for a building comprises dehumidifying unit, a ventilation unit and a control unit operably connected to both the dehumidifying unit and the ventilation unit for selectively actuating both units. The dehumidifying unit is mounted in at least one of an entry doorway, a floor, an interior wall and an exterior wall of the building for conditioning air as it moves through or into the building. The dehumidifying unit includes a housing having an air inlet and an air outlet located downstream from the air inlet. A fan and motor assembly is mounted on the housing. A stationary desiccant block is mounted in the housing downstream from the housing air inlet, for reducing a relative humidity of air flowing through the dehumidifying unit. A regenerative heater is disposed within the housing adjacent the desiccant block, for regenerating the desiccant block. The ventilation unit is spaced from and communicates with the dehumidifying unit, for expelling air from the building to atmosphere.

In accordance with yet another aspect of the present disclosure, a ventilation and desiccant dehumidifying system for a building includes a dehumidifying unit, a ventilation unit and a control unit. The dehumidifying unit is mounted in at least one of an entry doorway, a floor, an interior wall and exterior wall of the building for conditioning air as it moves through or into the building. The dehumidifying unit includes a housing having an air inlet and an air outlet located downstream from the inlet. The air inlet communicates with at least one of air within the building and atmosphere and the air outlet communicates with air within the building. A fan and motor assembly is mounted on the housing. A stationary desiccant block is mounted in the housing downstream from the housing air inlet for reducing a relative humidity of air flowing through the dehumidifying unit. The desiccant block is interposed between a pair of porous barrier layers. A heater is disposed within the housing adjacent the desiccant block for heating the desiccant block. The ventilation unit is spaced from the dehumidifying unit for expelling air from the building to atmosphere. The ventilation unit includes a fan and motor assembly and a housing. The housing includes an air inlet located adjacent a floor or ground surface and an air outlet spaced from the floor or ground surface. The air inlet communicates with air within the building and the air outlet communicates with atmosphere. The fan and motor assembly is located in the housing downstream from the air inlet and upstream from the air outlet. The control assembly is operably connected to both the dehumidifying unit and the ventilation unit for selectively actuating each unit in order to regulate a rate of air flow through each unit.

In accordance with still yet another aspect of the present disclosure, a ventilation and air exchange system for a building comprises an air exchange unit, a ventilation unit, and a control unit. The air exchange unit conditions air as it moves through or into the building. The air exchange unit includes a housing having a first air inlet, a second air inlet and an air outlet located downstream from the first and second air inlets. The first air inlet is in communication with air inside the building. The second air inlet is in communication with air outside the building. The air outlet directs a mixture of inside air and outside air into the building. A fan and motor assembly is mounted on the housing. The ventilation unit is spaced from and communicates with the air exchange unit for expelling air from the building to atmosphere. The control unit is operably connected to both the air exchange unit and the ventilation unit for selectively actuating both units.

Still other non-limiting aspects of the present disclosure will become apparent from a reading and understanding of the description of the embodiments hereinbelow.

### BRIEF DESCRIPTION OF THE DRAWINGS

The disclosure may take physical form in various components and arrangements of components, and in various steps and arrangements of steps. The drawings are only for purposes of illustrating embodiments of the disclosure and are not to be construed as limiting the disclosure.

FIG. 1 is schematic view of a building, with, some parts broken away, having a below grade foundation with a ventilation and dehumidifying system in accordance with a first embodiment of the present disclosure.

FIG. 2 is an enlarged exploded perspective view of a dehumidifying unit of the ventilation and dehumidifying system of FIG. 1.

FIG. 3 is an enlarged schematic cross-sectional view of a ventilation unit of the ventilation and dehumidifying system of FIG. 1.

FIG. 4 is an enlarged perspective view of the dehumidifying unit of FIG. 2 mounted to a door leading to a basement area.

FIG. 5 is schematic view of a building, with certain parts broken away, having a below grade foundation wall employing a ventilation and dehumidifying system in accordance with a second embodiment of the present disclosure.

FIG. 6 is schematic view of a building, with one wall broken away, having an above grade foundation wall employing a ventilation and dehumidifying system in accordance with a third embodiment of the present disclosure.

FIG. 7 is schematic view of a building, with one wall broken away, having a below grade foundation employing a ventilation and dehumidifying system in accordance with a fourth embodiment of the present disclosure.

FIG. 8 is a simplified operational schematic of a ventilation system in accordance with one embodiment of the present disclosure.

FIG. 9 is an alternative simplified operational schematic of a ventilation system in accordance with another embodiment of the present disclosure.

FIG. 10a is a bottom perspective view of an air exchange unit for a ventilation system in accordance with a fourth embodiment of the present disclosure.

FIG. 10b is a top perspective view of the air exchange unit of FIG. 10a.

FIG. 11 is schematic cross-sectional view of an ventilation and air exchange system for a building having a below grade foundation employing a ventilation and dehumidifying system in accordance with a fifth embodiment of the present disclosure.

FIG. 12 is schematic cross-sectional view of an ventilation and air exchange system for a building having a below grade foundation employing a ventilation and dehumidifying system in accordance with a sixth embodiment of the present disclosure.

FIG. 13 is schematic cross-sectional view of an ventilation and air exchange system for a building having a below grade foundation employing a ventilation and dehumidifying system in accordance with a seventh embodiment of the present disclosure.

FIG. 14 is schematic view of a building, with one wall broken away, having a below grade foundation employing the ventilation and air exchange system of FIG. 13.

FIG. 15 is schematic view of a building, with one wall broken away, having an above grade foundation employing the ventilation and air exchange system of FIG. 13.

FIG. 16 is schematic view of a building, with one wall broken away, having an above grade foundation employing a ventilation and air exchange system in accordance with an eighth embodiment of the present disclosure.

FIG. 17 is schematic view of a building, with one wall broken away, having a below grade foundation employing a ventilation and air exchange system in accordance with a ninth embodiment of the present disclosure.

FIG. 18 is a simplified operational schematic of a ventilation system in accordance with yet another embodiment of the present disclosure.

### DETAILED DESCRIPTION

It should, of course, be understood that the description and drawings herein are merely illustrative and that various modifications and changes can be made in the systems disclosed without departing from the spirit of the disclosure. Like numerals refer to like components throughout the several views. It will also be appreciated that the various identified components of the system disclosed herein are merely terms of art that may vary from one manufacturer to another and should not be deemed to limit the present disclosure.

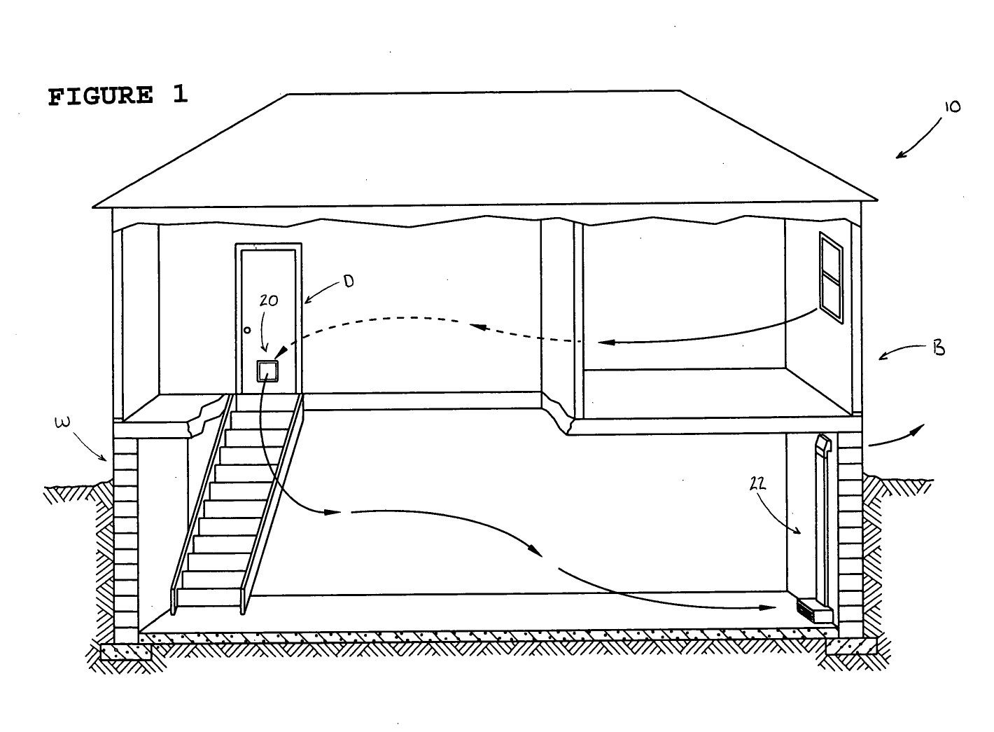

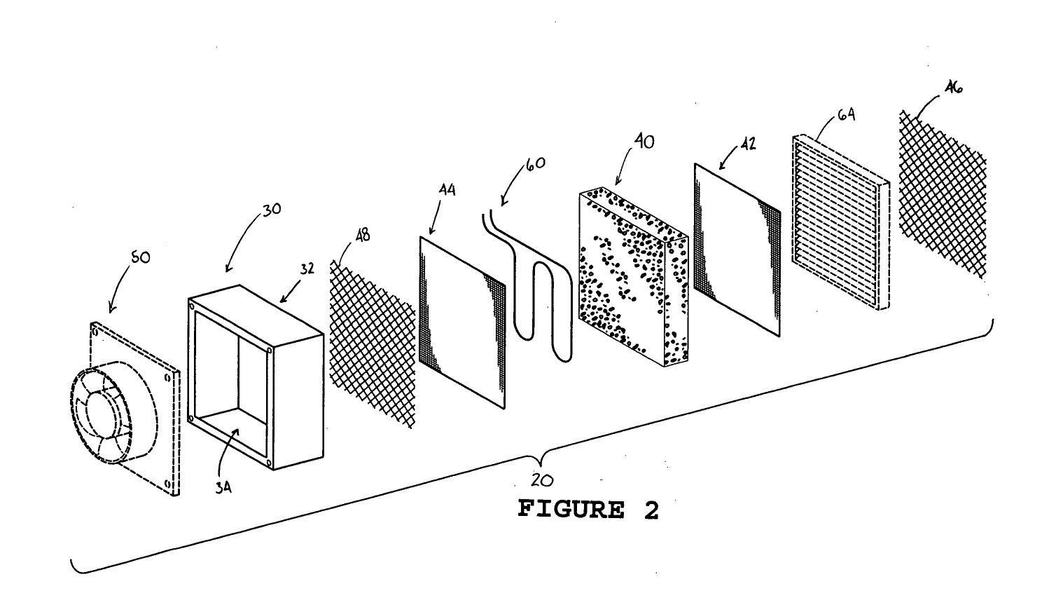

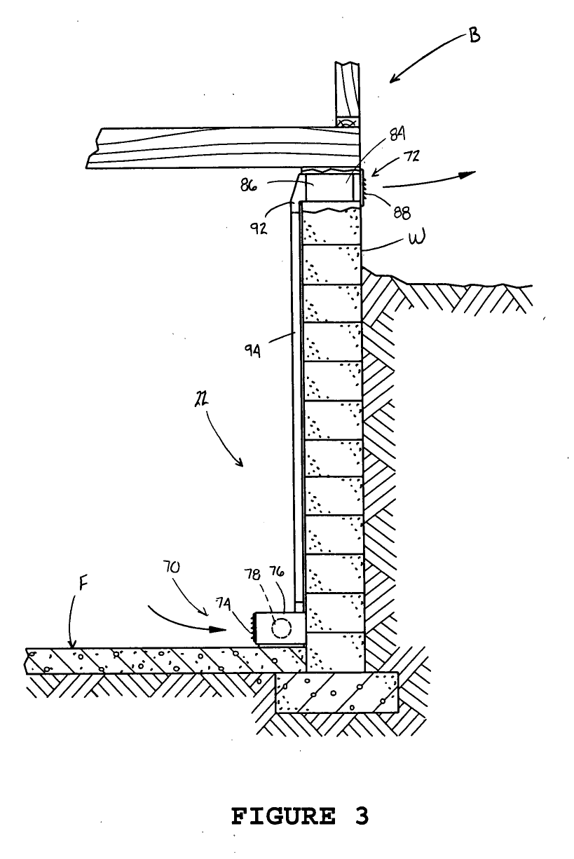

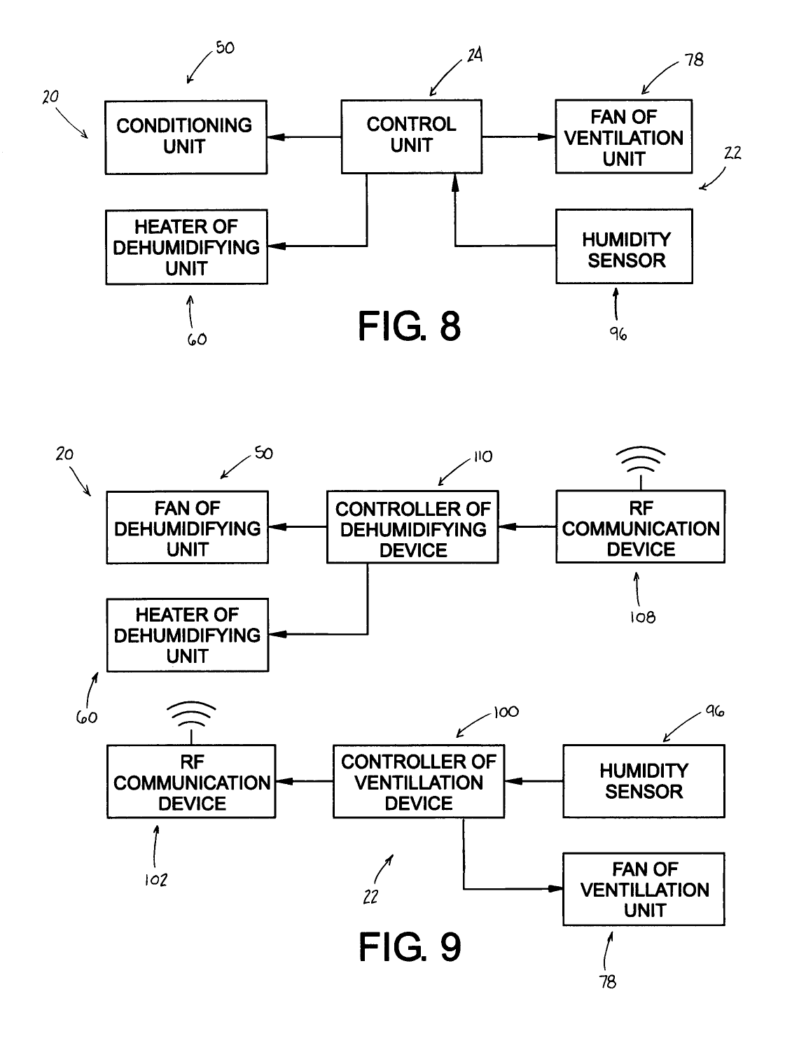

Referring now to the drawings wherein the showings are for purposes of illustrating several embodiments of the disclosure only and not for purposes of limiting the same, FIG. 1 illustrates a ventilation and dehumidifying system 10 for a building B having a below grade foundation wall W in accordance with a first embodiment of the present disclosure. The system 10 generally comprises a conditioning unit 20 (FIG. 2) and a ventilation unit 22 (FIG. 3). In this embodiment, the conditioning unit 20 is a dehumidifying unit. A control unit 24 (shown schematically in FIG. 8) communicates with both the dehumidifying unit 20 and the ventilation unit 22 for selectively actuating the dehumidifying unit when the ventilation unit is actuated in order to regulate a rate of air flow through the dehumidifying unit.

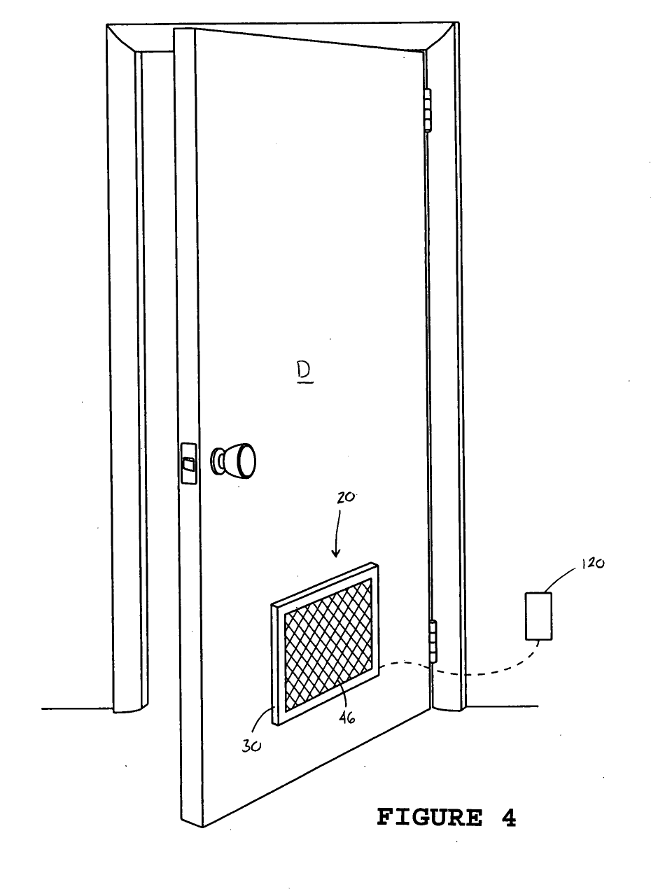

The dehumidifying unit 20 conditions air as it moves into an enclosed space, such as a basement, crawl space, or living area, above or below ground. The dehumidifying unit can be placed in a basement entry doorway, in a floor, in an interior wall or an exterior wall. In the depicted embodiment of FIGS. 1 and 4, the dehumidifying unit is mounted to a door D leading to a basement area of the building. In particular, the door includes an opening dimensioned to receive a housing 30 of the dehumidifying unit. The control unit 24 is mounted to a wall adjacent the door.

With reference to FIG. 2, the dehumidifying unit 20 generally includes the housing 30 having an air inlet 32 and an air outlet 34 located downstream from the air inlet. The housing can be rectangular in cross-section; however, it should be appreciated that the housing can have alternative conformations. The air inlet communicates with at least one of air within the building B and atmosphere and the air outlet communicates with air within the building. A stationary, motionless desiccant block 40 is mounted in the housing downstream from the housing air inlet 32 for reducing a relative humidity of air flowing through the dehumidifying unit. The desiccant block, which can be removable from the dehumidifying unit housing 30, can conform to the size and shape of the housing so that a cross-section of the housing is filled by the desiccant block. A surface area of the desiccant block can be generally between about seventy-two (72) square inches and about one hundred sixty (160) square inches.

The desiccant block 40 acts to dehumidify a current of air as it passes through the block. In one embodiment, the desiccant block 40 comprises one or more layers of silica beads held between a pair of porous barrier layers 42, 44. The barrier layers are designed to allow air to pass through and can be made of a cloth material, such as cheesecloth; although, this is not required. It should be appreciated that the desiccant block can be formed of a substrate material, such as fiberglass, paper, aluminum, and titanium, on which desiccant material, such as a silica gel, has been coated or impregnated. The dehumidifying unit 20 further includes a second pair of porous barrier layers, such as screens 46, 48 which are also designed to allow air to pass through. One screen 46 is mounted adjacent the air inlet 32 and the other screen 48 is mounted adjacent the air outlet 34.

The stationary desiccant block 40 adsorbs or absorbs moisture from the air stream until the block adsorbs or absorbs its moisture capacity. At that point the block would need to be dried or regenerated before it could operate to dehumidify again. For this reason, desiccants known in the art are shaped like a wheel. Such wheels continually transfer moisture between two air streams, constantly adsorbing moisture in one stream, rotating to the second, less humid air stream, and there releasing the moisture to the air stream. The present system, however, by using a fixed block desiccant avoids the substantial cost, reliability and maintenance issues that accompany the use of motors to spin or rotate the desiccant wheels.

With continued reference to FIG. 2, a blower system, such as a fan and motor assembly 50, can be mounted on the housing 30 over the air outlet 34 to generate an air current which flows from the air inlet 32, through the desiccant block 40 and out the air outlet into the enclosed space. It should be appreciated that the motor and fan assemble can also be mounted in the housing 30, if so desired. Examples of fan and motor assemblies include cage blowers, axial fans, propellers and other devices capable of creating a current of air.

A heater 60 is disposed within the housing 30 adjacent the desiccant block 40 in order to regenerate or dry the desiccant block when in operation. The heater may be configured as an electric heating element; although, it should be appreciated that other heater systems are also contemplated. The heater 60 can work in one of two ways. For indoor applications, the heater comes on periodically, to regenerate the desiccant block 40, and reduce the amount of moisture the desiccant block is holding. The heater 60 can have a constant on setting, for enclosed building spaces that are not heated. For outdoor applications, the heating element would have a seasonal setting, such as a periodic setting for summer use, and a constant setting for winter use.

In order to detect when the desiccant block 40 requires reactivation, the system 10 can include a sensor (not shown) configured to measure the humidity of the air before entering the desiccant block and after exiting the desiccant block. When the change in humidity becomes relatively small, the desiccant block would require regeneration. A sensor can be connected directly to the heater 60 such that when the sensor detects a relatively small humidity change, the heater will be actuated. Alternatively, a sensor can communicate with the control unit 24. When the change in humidity becomes relatively small, the control unit will actuate the heater 60 to regenerate the desiccant block 40.

The dehumidifying unit 20 can comprises an air filter 64 located upstream of the desiccant block 40 for filtering dirt from the airstream flowing through the dehumidifying unit. The filter 64 can comprise a pleated filter material and can be an electrostatic or High-Efficiency Particulate Arresting (HEPA) grade filter, which is capable of trapping very small dust particles. The dehumidifying unit 20 can further include an ultraviolet light (UV) source (not shown) for disinfecting the airstream inside the housing 30. Generally, the UV light source generates a magnetic or electric field capable of emitting radiation powerful enough to destroy bacteria and viruses.

With reference to FIG. 3, the ventilation unit 22, which is spaced from and communicates with the dehumidifying unit 20, expels air from the building B to atmosphere. The ventilation unit includes an air inlet 70 and an exhaust air outlet 72 spaced from the air inlet. The air inlet, which is typically positioned adjacent a low point of the building, communicates with air within the building and the exhaust air outlet communicates with atmosphere. The air inlet can include a plurality of louvers 74; although, this is not required.

The ventilation unit 22 includes a motor and fan housing 76 which houses a motor and fan assembly 78. As shown in FIG. 1, the motor and fan housing can be positioned adjacent the basement floor F of the building. However, the housing 76 may also be positioned adjacent the ceiling of the basement or in other desired locations. The motor and fan housing draws air within the enclosed building space through the air inlet 70 and exhausts it from the building through the exhaust air outlet 72.

The ventilation unit 22 further includes an exhaust opening 84 which is located within the wall of the building and spaced from the motor and fan housing 76. The exhaust opening can be located above the motor and fan housing. In one embodiment, the inlet 74 is located adjacent the floor F and the exhaust opening 86 is located adjacent a ceiling. The exhaust opening further includes a housing 86 having a plurality of louvers or vents 88 on an outside surface. Opposite the vents of the housing 86 is inlet 92. A conduit 94 communicates with the air inlet of the housing 86 and an air outlet of the motor and fan housing 76. The conduit can be an elongated duct which extends vertically within or on a wall of the building. In the embodiment of FIG. 3, if the basement room is unfinished, the conduit can simply be located adjacent the concrete blocks of the basement wall W.

As shown in FIG. 8, a humidity sensor 96, for reading a relative humidity of the air within the building, can be operably connected to the ventilation unit 22. The humidity sensor 96 communicates with the control unit 24 such that when the relative humidity rises above a predetermined amount, the motor and fan assembly 78 of the ventilation unit is actuated by the control unit. The control unit 24 can also selectively actuate the motor and fan assembly 50 of the conditioning unit or dehumidifying unit 20. As indicated above, if the change in humidity flowing through the desiccant block 40 becomes relatively small, in one embodiment, the control unit 24 can activate the heater 60 to regenerate the desiccant block. The desired humidity levels can be set by the homeowner/user. Alternatively, the system 10 may be electrically connected to a home thermostat (not shown) for monitoring indoor air conditions.

As indicated above, the control unit 24 regulates the ventilation and dehumidifying system 10 by selectively actuating the respective motor and fan assembly of both the dehumidifying unit 20 and the ventilation unit 22 in order to regulate a rate of air flow through each unit. In operation, the control unit 24 selectively, and in certain circumstances simultaneously, actuates the motor and fan assembly 50 of the dehumidifying unit 20 at a predetermined speed, which is related to the speed of the motor and fan assembly 78 of the ventilation unit 22, to prevent or reduce negative pressure within the building. Such a feature is particularly useful in newer homes or buildings which are designed to have a tight building envelope, i.e., little air flows into the building because the building has few air leaks. The control unit 24 can comprise a wiring harness which communicates directly with the motor and fan assembly 50 and heater 60 of the dehumidifying unit 20 and the motor and fan assembly 78 of the ventilation unit 22.

Alternatively, the control unit can comprises a wireless communication system, such as an RF communication system, which connects the dehumidifying unit 20 and the ventilation unit 22 via a control system. As shown in FIG. 9, the humidity sensor 96 can be operably connected to a first control unit 100 of the ventilation unit 22. The humidity sensor communicates with the first control unit such that when the relative humidity rises above a predetermined amount, the motor and fan assembly 78 of the ventilation unit is actuated by the first control unit. The first control unit 100 is connected to a first RF communication system 102 which communicates with a second RF communication system 108 of the dehumidifying unit 20. The second RF communication system is connected to a second control unit 110 of the dehumidifying unit. As the ventilation unit is actuated, the first control unit can selectively communicate with the second control unit which, in turn, can selectively actuate the motor and fan assembly 50 and heater 60, when needed, of the dehumidifying unit.

Referring again to FIG. 1, in one embodiment, the ventilation and dehumidifying system 10 is installed in a building B having a below grade foundation wall W. The dehumidifying unit 20 is mounted in a basement entry door D and can be electrically connected to a wall outlet 120 (FIG. 4). The ventilation unit 22 is mounted in the basement adjacent the foundation wall. In operation, the control unit 24 selectively actuates both units. Air entering into the enclosed space, for example via a window, is drawn into the dehumidifying unit via the fan and motor assembly 50 and passes through the desiccant block 40 which reduces the air's relative humidity. At the same time, the ventilation unit is drawing humid air from the lowest point of the basement area and is expelling it to the atmosphere. The conditioned, lower relative humidity air is moved through the basement area by the fan and motor assembly 78 of the ventilation unit. This conditioning of air lowers the relative humidity in the enclosed space, without the need for additional conditioning above and beyond what already exists in the home or building.

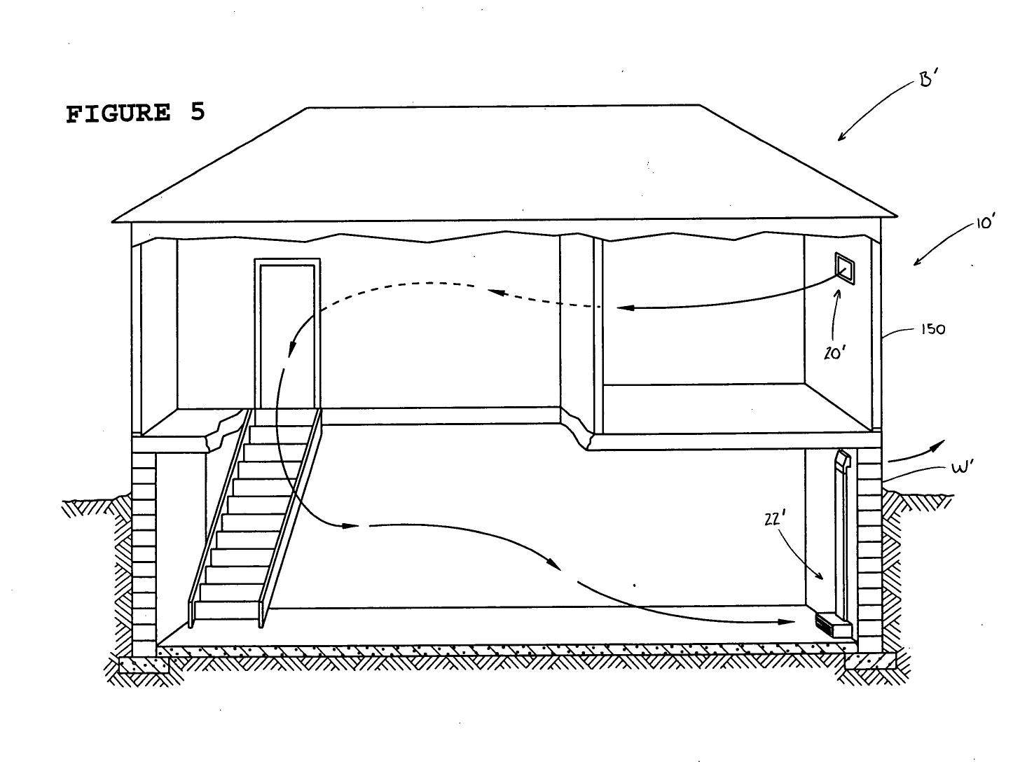

Alternative arrangements of the ventilation and dehumidifying system are schematically illustrated in FIGS. 5-7. Since most of the structure and function is substantially identical, reference numerals with a primed suffix (′) refer to like components, and new numerals identify new components in the additional arrangements. It should be appreciated that the alternative arrangement are examples only and that other arrangements are also contemplated.

With reference to FIG. 5, a ventilation and dehumidifying system 10′ is installed in a building B′ having a layout similar to the building of FIG. 1. A dehumidifying unit 20′ is mounted in an exterior wall 150 of the building. In this embodiment, an inlet to the dehumidifying unit can include louvers or vents which can seal off the inlet when the unit is not activated. A ventilation unit 22′ is mounted in the basement adjacent a foundation wall W′. In operation, a control unit selectively actuates both units. The dehumidifying unit draws air into an enclosed space from outside of the building. The air flows through a desiccant block which reduces the air's relative humidity. At the same time, the ventilation unit, which is drawing humid air from the basement and is expelling it to the atmosphere, is also drawing the conditioned air into the basement area. The conditioned, lower relative humidity air is then moved through the basement area and towards the ventilation unit 22′. Once the humidity sensor 96 senses the decreased humidity in the air, the system is shut off. When the humidity in the basement air increases again, the cycle begins again.

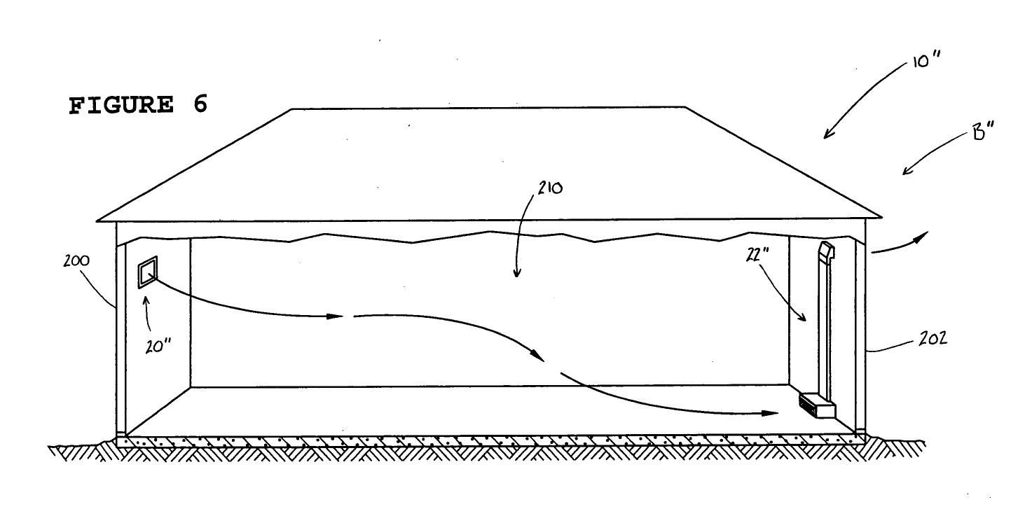

With reference to FIG. 6, a ventilation and dehumidifying system 10″ is installed in a slab building B″ having no basement. A dehumidifying unit 20″ is mounted in one exterior wall 200. A ventilation unit 22″ is mounted adjacent a second exterior wall 202. In operation, a control unit selectively actuates both units. The dehumidifying unit draws air into an enclosed space 210 from outside of the building. The air flows through a desiccant block which reduces the air's relative humidity. At the same time, the ventilation unit is drawing humid air from the enclosed space and is expelling it to the atmosphere. The conditioned, lower relative humidity air is then moved into the enclosed space. It is eventually expelled by the ventilation unit into atmosphere, after it has become humid.

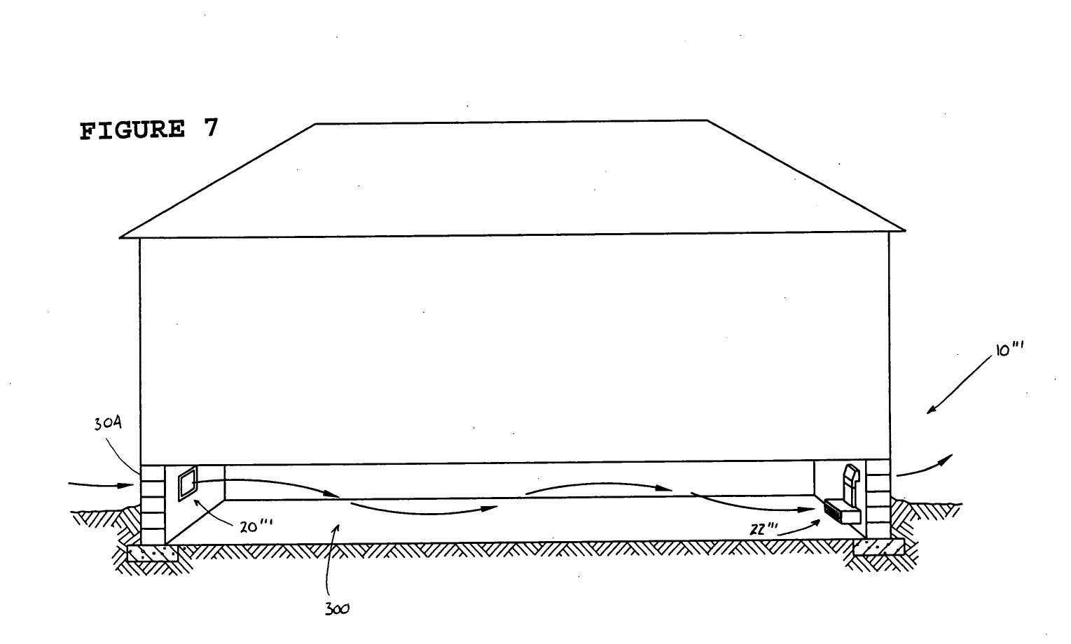

With reference to FIG. 7, a ventilation and dehumidifying system 10′″ is installed in a building B′″ having a crawl space 300 where no doorway exists between a living area and the crawl space area. In this case, a dehumidifying unit 20′″ would be positioned in one or more vent openings (not shown) that are located around the outside wall 304 areas of the crawl space. This would allow for the outside air to be conditioned as it enters the crawl space area. The other vents present in the crawl space would be sealed. The remaining vents would be strategically placed, so that incoming air would travel across the crawl space area before exiting through the ventilation unit 22′″.

Each fan and motor assembly 50, 78 can be rated at about 177 cubic feet per minute (cfm) and have a noise level of about 48 decibels (db). In other words, a very quiet fan and motor assembly is used so as not to disturb occupants in the building. According to another embodiment, each fan and motor assembly can have a variable speed in order to have an output of anywhere from 0 to 1000 cfm depending upon the amount of square feet in the building. The speed of each motor and fan assembly 50, 78 can be selectively controlled by the control unit 24.

The ventilation and dehumidifying system of the present disclosure reduces moisture in an enclosed space of a building, together with mold and mildew. This has numerous advantages. Moisture can cause allergy problems by encouraging dust mites, dry rot and insects. It can also cause mold spores which may pose serious health risks. As is known, hazardous mold and mildew can make any space unusable. Also, the system of the present disclosure increases the amount of airflow in the building in which it is installed.

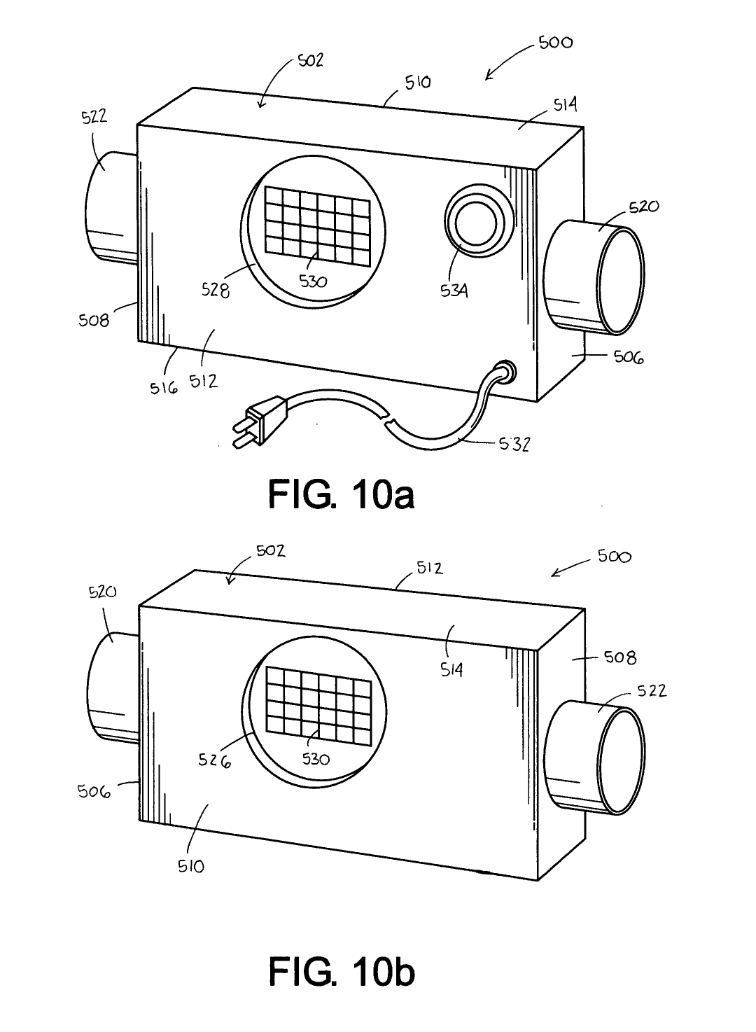

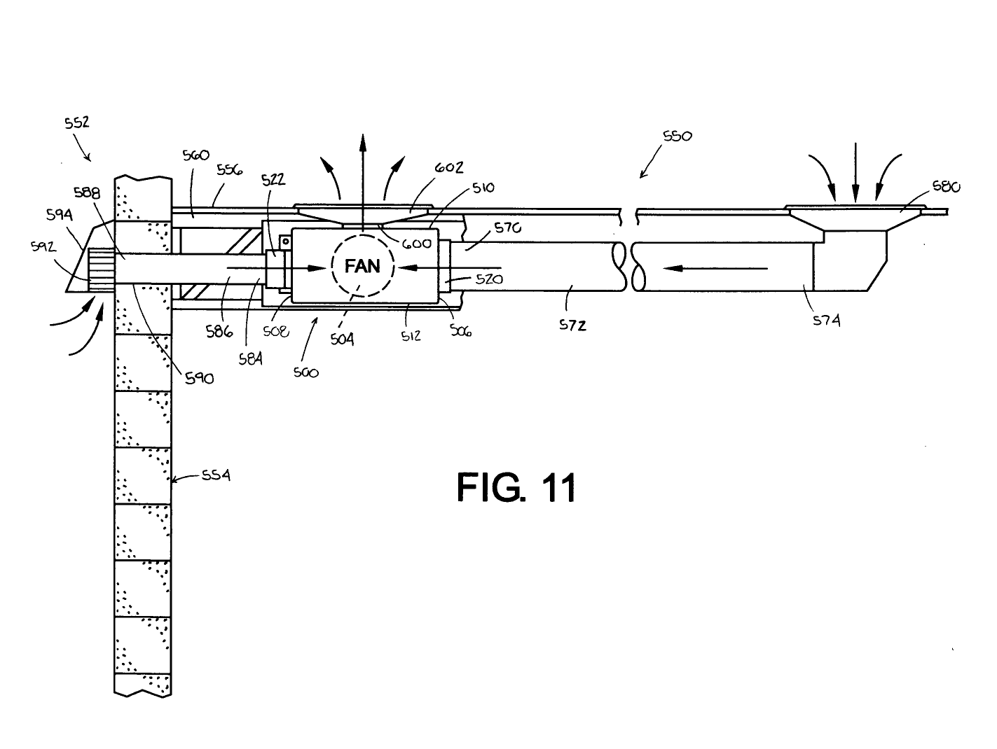

With reference to FIGS. 10a, 10b and 11, a conditioning unit 500 for a ventilation system 550 according to a fifth embodiment of the present disclosure is shown. In this embodiment, the conditioning unit comprises an air exchange unit. Thus, a conditioning unit can be either an air exchange unit or a dehumidifying unit. Both the air exchange unit and the dehumidifying unit include a fan. But only the dehumidifying unit also includes a dessicant material.

The air exchange unit draws filtered outside air into a building, mixes the fresh outside air with inside air to condition the outside air (both in terms of temperature and humidity), and introduces the fresh, clean conditioned air into the building. As shown in FIGS. 10a and 10b, the air exchange unit 500 includes a housing 502 for housing an air intake fan 504 (schematically illustrated in FIG. 11). In the depicted embodiment, the housing has a rectangular shape and includes opposing first and second sidewalls 506 and 508, respectively, a top wall 510, a bottom wall 512, and opposing end walls 514 and 516. Alternative shapes for the air exchange unit are also contemplated. An inside air intake 520 is located on the first side wall 506 and an outside fresh air intake 522 is located on the second side wall 508. The inside and outside air intakes are located on the respective end walls; although, this is not required. As will be discussed in greater detail below, the inside air intake 520 can have a larger dimension than the outside air intake 522. A first mixed air outlet 526 is located on the top wall 510. A separate second mixed air outlet 528 is located on the bottom wall 512. A screen or grill 530 at least partially covers each outlet; although, this is not required. An electric power cord 532 extends from the bottom wall 512 for providing a power source to the intake fan 504. A control 534 is provided on the housing 502 for operating the air exchange unit 500.

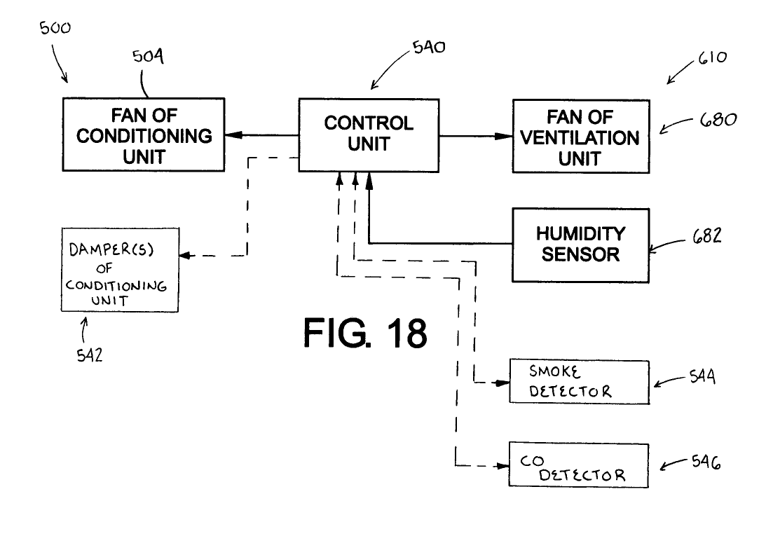

To control the flow of air through the air exchange unit, the speed of the intake fan can be controlled by a control unit 540 (schematically illustrated in FIG. 18), which is similar to control unit 24 schematically illustrated in FIG. 8. The control unit 540 can communicate with control 534 located on the air exchange unit. Alternatively, the control unit 540 and control 534 can be one unit locate on the air exchange unit. To further control the flow of air through the air exchange unit 500, motorized dampers 542 (FIG. 18) can be used. A first damper can be placed in the first conduit for controlling the flow of inside air into the system. A second damper can be positioned in the second conduit for controlling the flow of outside air into the system. Third and fourth dampers can be positioned near the respective first and second mixed air outlets 526, 528, respectively, to control the flow of mixed air out of the system. The dampers can be selectively actuated via the control 534. A smoke detector 544 and carbon monoxide (CO) detector 546 (FIG. 18) can be operably connected to the control 534 of the air exchange unit 500. Upon detection of smoke, the control can close the first conduit, for example, by actuating the first damper. Upon detection of carbon monoxide, the control can initiate fresh air intake from outside of the building.

Similar to the dehumidifying unit 20 described above, to further condition the air within the housing 502, the air exchange unit 500 can also include a stationary, motionless desiccant block (not shown) mounted in the housing 502 for reducing a relative humidity of air flowing through the air exchange unit. A heater (not shown) can be disposed within the housing adjacent the desiccant block in order to regenerate or dry the desiccant block when in operation. Of course, another type of known dessicant unit can also be used.

As shown in FIG. 11, the ventilation and air exchange system 550 is installed in a building 552 having a below grade foundation wall 554. The air exchange unit 500 is mounted below a sub floor 556 adjacent one of the trusses 560. A first end section 570 of a first conduit 572 is coupled to the inside air intake 520. A second end section 574 of the first conduit is coupled to a floor register 580. In one embodiment, the length of the first conduit can be at least eight (8) feet, which allows for sufficient separation from the first mixed air outlet 526 so that there will not be a continuous recycling of the same air. A first end section 584 of a second conduit 586 is coupled to the outside air intake 522. A second end section 588 of the second conduit extends through an opening 590 located in the foundation wall 554. A filter 592 for cleaning the outside air, such as a standard filter media and/or a HEPA filter media, is located adjacent the second end section 588. A cover 594, removably mounted to the wall, protects the filter from the environment. An inlet to the cover can include louvers or vents which can seal off the inlet when the air exchange unit is not activated. In the illustrated embodiment, the first conduit 572 has a larger diameter than the second conduit 586; although, this is not required. However, in one embodiment the first conduit has twice the diameter of the second conduit. In this way, two thirds of interior air is mixed with one third outside air when the system 550 is operating. A third conduit 600 connects the first mixed air outlet 526 to a separate floor register 602.

In use, the control 534 selectively actuates the air exchange unit 500. The air exchange unit draws air into the first conduit from floor register 580 inside the building 552 and simultaneously pulls air into the second conduit from outside of the building. The inside and outside air streams mix within the housing 502 (FIGS. 10a, 10b), the inside air being used to at least partially temper the outside air. The mixed, conditioned air is then passed into the building through the first mixed air outlet 526 and floor register 602. As indicated above, the second mixed air outlet 528 can be closed by a damper. If desired, the conditioned air can be then be moved into the basement area and expelled by a ventilation unit (not shown) installed in the basement into atmosphere. Such a ventilation unit is similar to ventilation unit 22 described above.

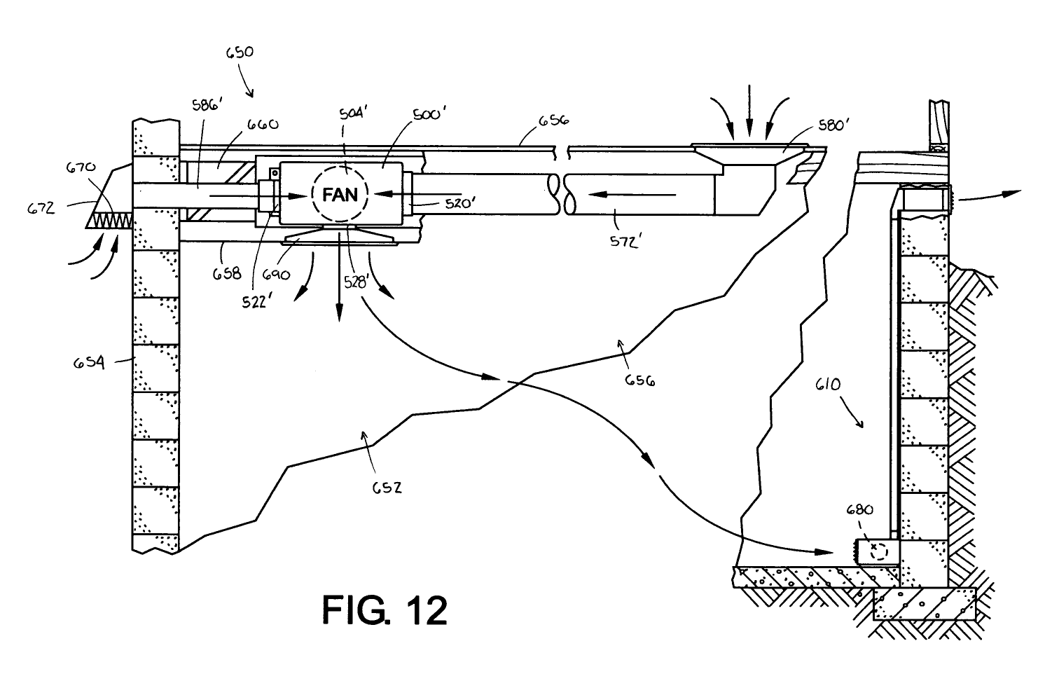

With reference to FIG. 12, a ventilation and air exchange system 650 according to a sixth embodiment of the present disclosure is shown. Since most of the structure and function is substantially identical to the previous embodiment, reference numerals with a single primed suffix (′) refer to like components (e.g., air exchange unit 500 is referred to by reference numeral 500′), and new numerals identify new components in the additional embodiment of FIG. 12. The primary distinctions relate to the use of first and second mixed air outlets.

As shown in FIG. 12, the ventilation and air exchange system 650 is installed in a building 652 having a below grade foundation wall 654 and a basement 656. The system generally includes an air exchange unit 500′ and a ventilation unit 610. The air exchange unit 500′ is mounted between a sub-floor 656 and a wall 658 of the basement adjacent one of the trusses 660. A first conduit 572′ is connected to an inside air intake 520′ and a floor register 580′. A second conduit 586′ is connected to the outside air intake 522′ and is in communication with fresh outside air. A filter 670 for cleaning the outside air is positioned in a cover 672 which can be removably mounted to the wall. The ventilation unit 610 is spaced from and communicates with the air exchange unit. The ventilation unit 610 is similar to ventilation unit 22 described above. Because the operation of the ventilation units are the same, detailed description thereof will be omitted for conciseness.

With reference to FIG. 18, in use, the control unit 540 regulates the ventilation and air exchange system 650 by selectively actuating the respective intake fan 504′ of the air exchange unit 500′ and motor and fan assembly 680 of the ventilation unit 610 in order to regulate a rate of air flow through each unit. The control unit selectively, and in certain circumstances simultaneously, actuates the intake fan of the air exchange unit at a predetermined speed, which is related to the speed of the motor and fan assembly of the ventilation unit, to prevent or reduce negative pressure within the building. Such a feature is particularly useful in newer homes or buildings which are designed to have a tight building envelope. The control unit 540 is configured to communicate directly with the air exchange unit 500′ and the ventilation unit 610. The control unit 540 can be located on the air exchange unit; although, this is not required. A humidity sensor 682, for reading a relative humidity of the air within the building, can be operably connected to the ventilation unit 610. The humidity sensor communicates with the control unit 540 such that when the relative humidity rises above a predetermined amount, the motor and fan assembly 680 of the ventilation unit is actuated by the control unit. The control unit 540 can also selectively actuate the motor and fan assembly 504′ of the conditioning unit or air exchange 500′. The desired humidity levels can be set by the homeowner/user. Alternatively, the system may be electrically connected to a home thermostat (not shown) for monitoring indoor air conditions.

The air exchange unit 500′ draws air into the first conduit from floor register 580′ inside the building and simultaneously pulls air into the second conduit from outside of the building. The inside and outside air streams mix within the air exchange unit. The conditioned air is then passed into the basement through a second mixed air outlet 528′ and a ceiling register 690. The conditioned, lower relative humidity air is then moved into the basement while relatively humid air located in the basement is expelled by the ventilation unit 610 (FIG. 12) into atmosphere. In this way, the relative humidity of the basement air is lowered, enhancing the livability of the basement.

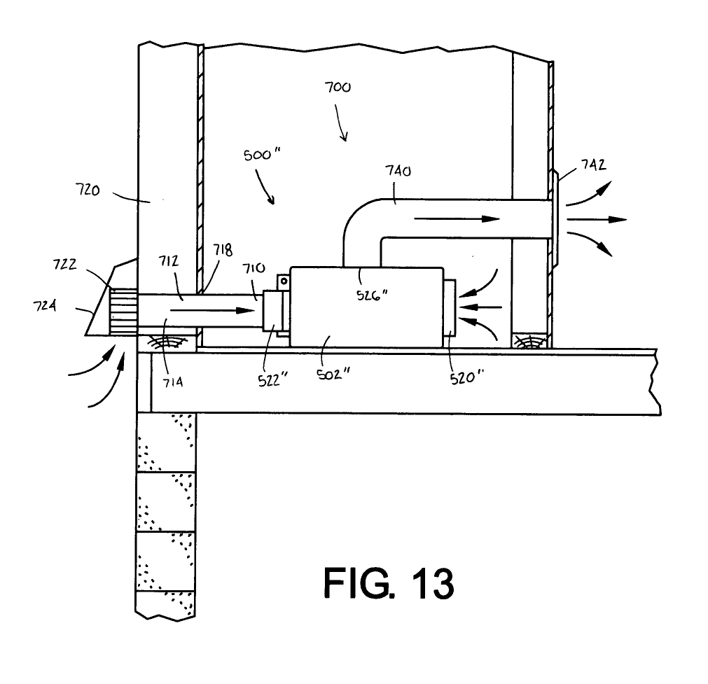

With reference to FIGS. 13-15, a ventilation and air exchange system 700 according to a seventh embodiment of the present disclosure is shown. Since most of the structure and function is substantially identical to the previous embodiments, reference numerals with a double primed suffix (″) refer to like components (e.g., air exchange unit 500 is referred to by reference numeral 500″), and new numerals identify new components.

As shown in FIG. 13, the ventilation and air exchange system 700 comprises an air exchange unit 500″ including a housing 502″, an inside air intake 520″, an outside fresh air intake 522″, and a mixed air outlet 526″. A first end section 710 of a first conduit 712 is coupled to the outside air intake. A second end section 714 of the conduit 712 extends through an opening 718 located in an exterior wall 720. A filter 722 for cleaning the outside air is positioned in a protective cover 724 removably mounted to the wall. A second conduit 740 connects the mixed air outlet 526″ to a separate inside wall register 742.

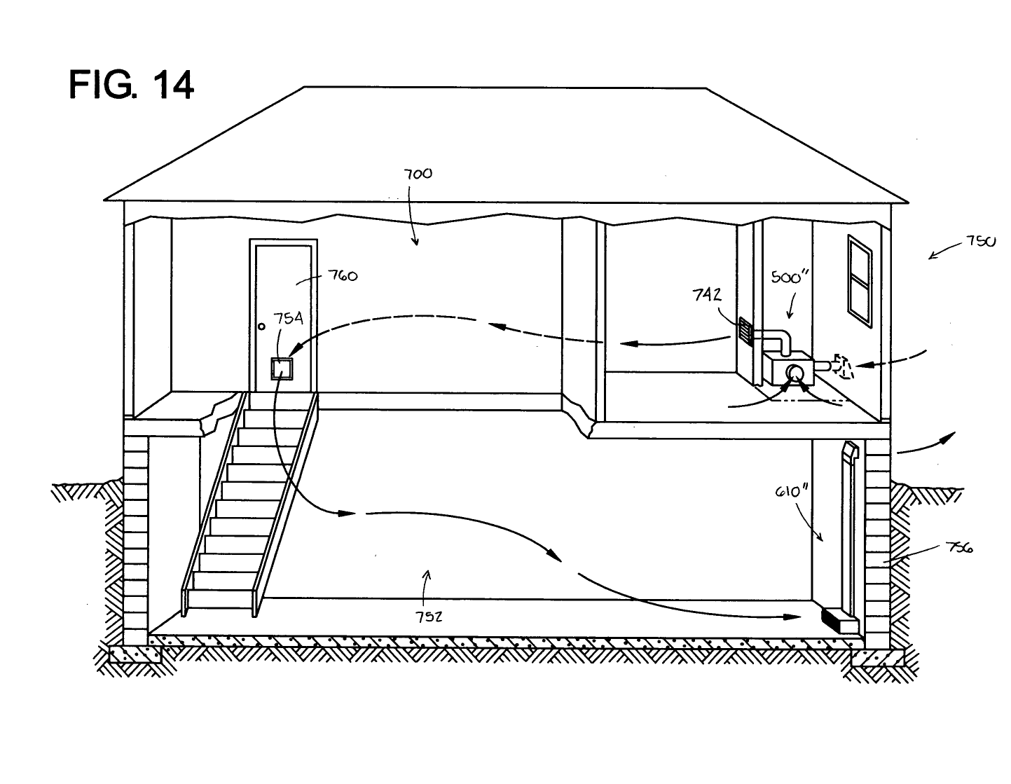

With reference to FIG. 14, the ventilation and air exchange system 700 is installed on an opposite side of a building 750 having a basement area 752. The installation in FIG. 14 is a mirror image of the installation in FIG. 13. A ventilation unit 610″ is mounted in the basement adjacent a foundation wall 756. In operation, a control unit selectively actuates both units. The air exchange unit draws fresh air into the housing 502″ from outside of the building. Inside air is pulled into the housing via the inside air intake 520″. A screen or grill (not visible) can at least partially cover the inside intake. The outside air and inside air are mixed and the mixture is exhausted through the mixed air outlet 526″ into the enclosed space via the wall register 742. At the same time, the ventilation unit, 610″ in the basement is drawing humid air from the basement and is expelling it to the atmosphere. The air in the basement is being replenished by the air from the ventilation and air exchange system. The conditioned air flows into the basement area 752. In this embodiment, the conditioned, lower relative humidity air moves through one of a vent or dehumidifying unit 754 located in a basement door 760 into the basement area and is also expelled by the ventilation unit into atmosphere. In one embodiment, the unit 754 can be a simple vent or louver mounted in the door 760. In another embodiment, the unit 754 can be a dehumidifying unit, such as the unit 20 described above. It should be appreciated that the control unit 540 for actuating the air exchange and ventilation units can also actuate the dehumidifying unit (if that is used) in a similar manner described above.

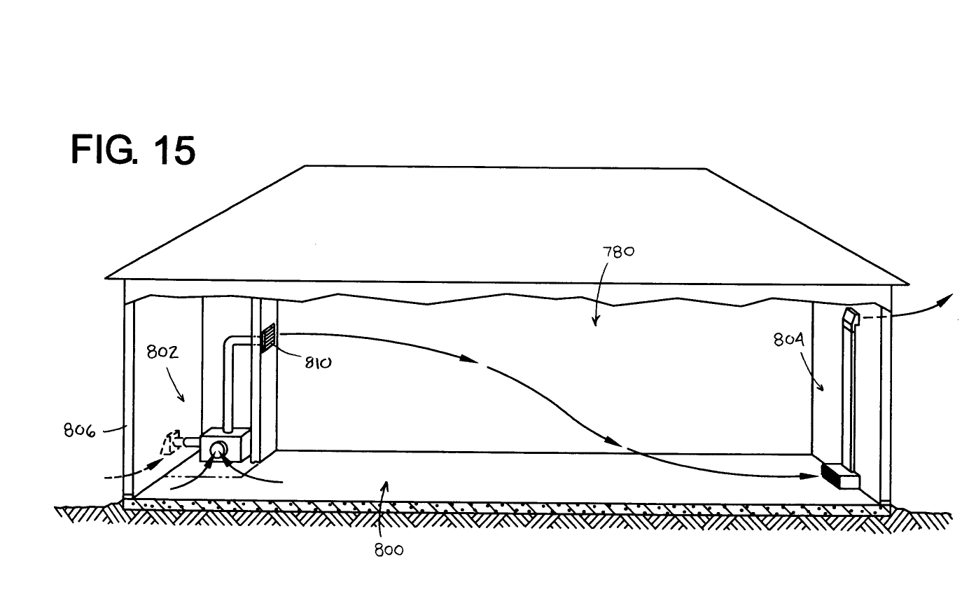

With reference to FIG. 15, a ventilation and air exchange system 780 is installed in a slab building 800 having no basement. In operation, a control unit selectively actuates both an air exchange unit 802 and ventilation unit 804. The air exchange unit pulls in fresh air through a wall 806 of the building 800, conditions the fresh air with inside air and expels the conditioned air into the enclosed space via an inside wall register 810. At the same time, the ventilation unit is drawing humid air from the enclosed space and is expelling it to the atmosphere. The conditioned, lower relative humidity air is then moved into the building 800. In this way, the relative humidity in the building can be controlled, enhancing its livability.

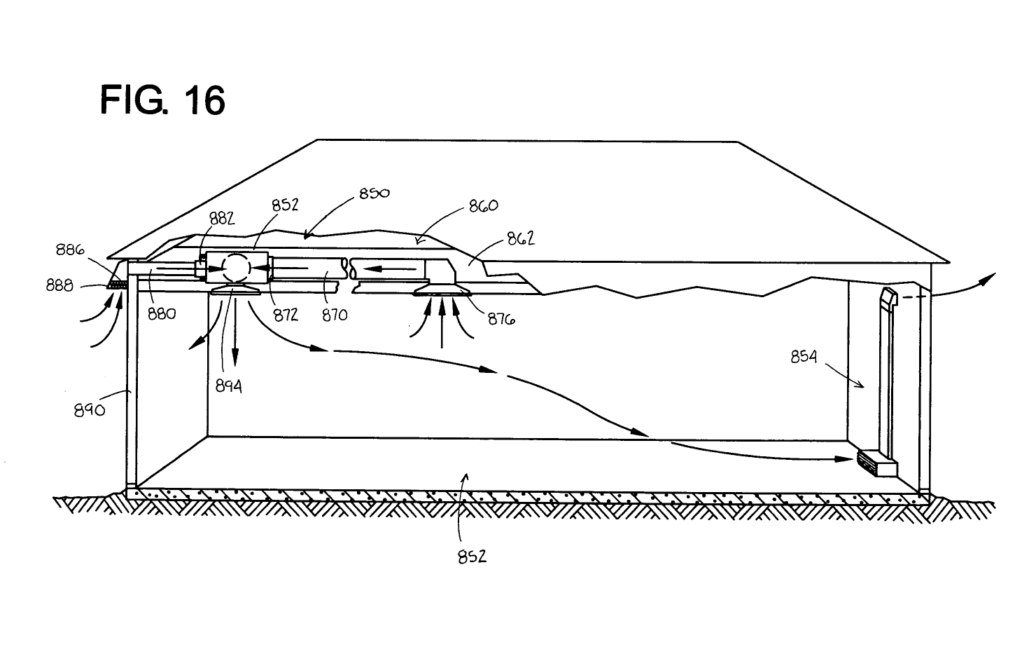

With reference to FIG. 16, a ventilation and air exchange system 850 according to an eighth embodiment of the present disclosure is installed in a building 852 having a layout similar to the slab building 800 of FIG. 15. The system generally includes an air exchange unit 852 and a ventilation unit 854, which is similar to the ventilation units described above. The air exchange unit is mounted in an attic 860 above between joists 862. A first conduit 870 is connected to an inside air intake 872 and a ceiling register 876. A second conduit 880 is connected to an outside air intake 882 and is in communication with fresh outside air. A filter 886 for cleaning the outside air is positioned in a cover 888 which can be removably mounted to a wall 890. The ventilation unit 854 is spaced from and communicates with the air exchange unit via the control unit 540 (as described above). In operation, the control unit selectively actuates both the air exchange unit 852 and the ventilation unit 854. The air exchange unit pulls in fresh outside air, conditions the fresh air with inside air and expels the conditioned air into the enclosed space via a separate ceiling register 894. At the same time, the ventilation unit is drawing humid air from the enclosed space and is expelling it to the atmosphere. The conditioned, lower relative humidity air is then moved through the building 852.

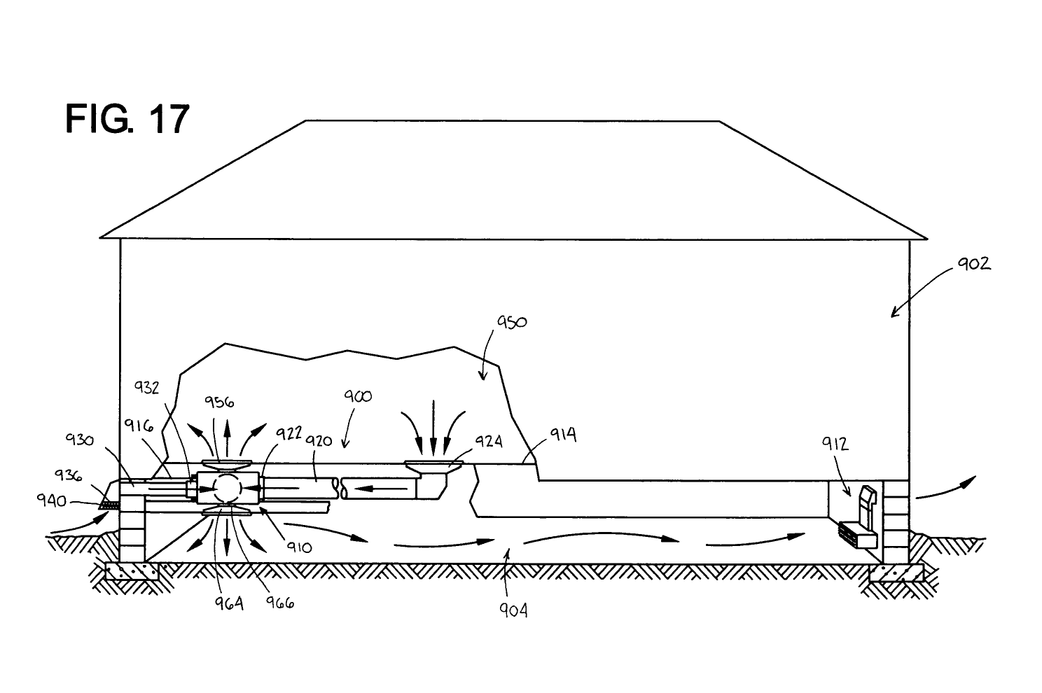

With reference to FIG. 17, a ventilation and air exchange system 900 according to a ninth embodiment of the present disclosure is installed in a building 902 having a crawl space 904. The system generally includes an air exchange unit 910 and a ventilation unit 912, which is similar to the ventilation units described above. The air exchange unit is mounted in the crawl space below a sub-floor 914 adjacent a truss 916. A first conduit 920 is connected to an inside air intake 922 and a first floor register 924. A second conduit 930 is connected to an outside air intake 932 and is in communication with fresh outside air. A filter 936 for cleaning the outside air is positioned in a cover 940 which can be removably mounted to a wall. The ventilation unit 912 is spaced from and communicates with the air exchange unit via the control unit 540 (as described above). In operation, the control unit selectively actuates both the air exchange unit and the ventilation unit. If the crawl space includes additional air vents, such additional air vents should be closed or sealed. The air exchange unit pulls in fresh outside air and conditions the fresh air with inside air from an enclosed space 950. The air exchange unit expels the conditioned air back into the enclosed space 950 via a second floor register 956 connected to a first mixed air outlet 960. The conditioned air is also expelled into the crawl space 904 via a register 964 connected to a second mixed air outlet 966. The balance or amount of conditioned air being directed into the enclosed space and crawl space can be varied by dampers (as described above) and/or the dimension of the mixed air outlets. For example, the air exchange unit can direct 50% of the air into the enclosed space and 50% of the air into the crawl space. At the same time, the ventilation unit 912 is drawing humid air from the crawl space and is expelling it to the atmosphere. The conditioned, lower relative humidity air is then moved through the crawl space 902.

The present disclosure has been described with reference to several embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

What we claim is:

1. A ventilation system for a building comprising:
a conditioning unit mounted in at least one of a door and a wall of the building for conditioning air as it moves through or into the building, the conditioning unit including a fan, at least one air inlet and at least one air outlet spaced from the at least one air inlet, wherein the at least one air inlet communicates with at least one of air within the building and atmosphere and wherein the at least one air outlet communicates with air within the building;
a ventilation unit spaced from and communicating with the conditioning unit for expelling air from the building to atmosphere, the ventilation unit including an air inlet and an exhaust air outlet spaced from the air inlet, wherein the air inlet communicates with air within the building and wherein the exhaust air outlet communicates with atmosphere; and
a control unit communicating with both the conditioning unit and the ventilation unit for actuating the conditioning unit when the ventilation unit is actuated in order to regulate a rate of air flow through the conditioning unit.

2. The system of claim 1, wherein the conditioning unit comprises a dehumidifying unit and further comprising a block of desiccant material removably mounted in a housing of the dehumidifying unit downstream from the at least one air inlet for reducing relative humidity of air flowing through the dehumidifying unit.

3. The system of claim 2, wherein the dehumidifying unit further comprises an air filter located upstream of the desiccant block.

4. The system of claim 2, wherein the dehumidifying unit further comprises a heater disposed within the housing adjacent the desiccant block for heating the desiccant block.

5. The system of claim 2, wherein the dehumidifying unit includes a pair of first porous barrier layers mounted to the housing and wherein the desiccant block is interposed between the pair of layers.

6. The system of claim 5, wherein the dehumidifying unit further includes a second pair of porous barrier layers, one layer being mounted adjacent the at least one air inlet and the other layer being mounted adjacent the air outlet.

7. The system of claim 1, wherein the ventilation unit further comprises a humidity sensor, communicating with the control unit, for reading a relative humidity of the air within the building, a motor and fan assembly of the ventilation unit being actuated by the control unit when the relative humidity rises above a predetermined amount.

8. The system of claim 1, wherein the air inlet of the ventilation unit is positioned adjacent a low point of the building.

9. The system of claim 1, wherein the ventilation unit includes a motor and fan assembly selectively actuated by the control unit.

10. The system of claim 9, wherein the control unit selectively actuates a motor and fan assembly of the conditioning unit at a predetermined speed which is related to the speed of the motor and fan assembly of the ventilation unit to prevent or reduce negative pressure within the building.

11. The system of claim 1, wherein the conditioning unit comprises an air exchange unit, the air exchange unit including a first air inlet in communication with atmosphere and a second air inlet in communication with air within the building, the air exchange unit being configured to mix two separate air streams and discharge the mixed conditioned air through the at least one air outlet back into the building.

12. The system of claim 11, wherein the at least one mixed air outlet of the air exchange unit is fluidly connected to an air register located in one of a floor, a ceiling and an interior wall of the building.

13. The system of claim 11, wherein the air exchange unit further comprises a control, communicating with the control unit, for actuating a motor and fan assembly of the air exchange unit at a predetermined speed which is related to the speed of the motor and fan assembly of the ventilation unit to prevent or reduce negative pressure within the building.

14. The system of claim 11, further including an air conduit having a first end section connected to an air register and a second end section connected to the second air inlet, the air conduit having a length of at least eight (8) feet to retard a continuous recycling of the same air.

15. A ventilation and dehumidifying system for a building comprising:
a dehumidifying unit mounted in at least one of an entry doorway, a floor, an interior wall and an exterior wall of the building for conditioning air as it moves through or into the building, the dehumidifying unit including:
a housing having an air inlet and an air outlet located downstream from the air inlet,
a fan and motor assembly mounted on the housing,
a stationary desiccant block mounted in the housing downstream from the housing air inlet for reducing a relative humidity of air flowing through the dehumidifying unit, and
a regenerative heater disposed within the housing adjacent the desiccant block for regenerating the desiccant block;
a ventilation unit spaced from and communicating with the dehumidifying unit for expelling air from the building to atmosphere; and
a control unit operably connected to both the dehumidifying unit and the ventilation unit for selectively actuating both units.

16. The system of claim 15 wherein the control unit comprises a wiring harness communicating with the fan and motor assembly of the dehumidifying unit and a motor and fan assembly of the ventilation unit.

17. The system of claim 15, wherein the control unit comprises a wireless communication system which connects the dehumidifying unit and the ventilation unit to the control unit.

18. The system of claim 17, wherein the fan and motor assembly of the dehumidifying unit and a motor and fan assembly of the ventilation unit are regulated by the control unit.

19. The system of claim 15, wherein the desiccant block is interposed between a pair of porous barrier layers.

20. The system of claim 15, wherein the ventilation unit further comprises a humidity sensor which communicates with the control unit, the control unit selectively actuating the ventilation unit and the dehumidifying unit when the humidity sensor indicates an excess of humidity in an area of the building.

21. The system of claim 15, wherein an air inlet of the ventilation unit is positioned adjacent the floor of the building, the ventilation unit further comprises an exhaust vent located in a wall of the building, spaced from, the floor of the building.

22. The system of claim 15, wherein the control unit operates the motor and fan assembly of the dehumidifying unit at a speed proportional to a speed of a motor and fan assembly of the ventilation unit, thereby reducing the possibility of a negative pressure within the building.

23. A ventilation and desiccant dehumidifying system for a building comprising:
a dehumidifying unit mounted in at least one of an entry doorway, a floor, an interior wall and an exterior wall of the building for conditioning air as it moves through or into the building, the dehumidifying unit including:
a housing having an air inlet and an air outlet located downstream from the inlet, wherein the air inlet communicates with at least one of air within the building and atmosphere and wherein the air outlet communicates with air within the building,
a fan and motor assembly mounted on the housing,
a stationary desiccant block mounted in the housing downstream from the housing air inlet for reducing a relative humidity of air flowing through the dehumidifying unit, the desiccant block being interposed between a pair of porous barrier layers, and
a heater disposed within the housing adjacent the desiccant block for heating the desiccant block;
a ventilation unit spaced from the dehumidifying unit for expelling air from the building to atmosphere, the ventilation unit including:
a fan and motor assembly and a housing, the housing including an air inlet located adjacent a floor or ground surface and an air outlet spaced from the floor or ground surface, wherein the air inlet communicates with air within the building and wherein the air outlet communicates with atmosphere, the fan and motor assembly being located in the housing downstream from the air inlet and upstream from the air outlet; and
a control assembly operably connected to both the dehumidifying unit and the ventilation unit for selectively actuating each unit in order to regulate a rate of air flow through each unit.

24. The system of claim 23, wherein the dehumidifying unit further comprises a pair of screens, one screen being mounted adjacent the air inlet and the other screen being mounted adjacent the air outlet.

25. The system of claim 23, wherein the dehumidifying unit further comprises an air filter mounted to the housing upstream from the desiccant block.

26. The system of claim 23, wherein the dehumidifying unit is mounted in a door leading to a basement area of the building.

27. The system of claim 23, wherein a surface area of the desiccant block is between about 72 square inches and about 160 square inches.

28. A ventilation and air exchange system for a building comprising:
an air exchange unit for conditioning air as it moves through or into the building, the air exchange unit including:
a housing having a first air inlet, a second air inlet and at least one air outlet located downstream from the first and second air inlets, the first air inlet being in communication with air inside the building, the second air inlet being in communication with air outside the building, the at least one air outlet directing a mixture of inside air and outside air into the building, and
a fan and motor assembly mounted to the housing;
a ventilation unit spaced from and communicating with the air exchange unit for expelling air from the building to atmosphere; and
a control unit operably connected to both the air exchange unit and the ventilation unit for selectively regulating the operation of both units.

29. The system of claim 28 wherein the control unit comprises at least one of:
a wiring harness communicating with the fan and motor assembly of the air exchange unit and a motor and fan assembly of the ventilation unit, and
a wireless communication system which connects the air exchange unit and the ventilation unit to the control unit.

30. The system of claim 29, wherein a speed of the fan and motor assembly of the air exchange unit and a speed of motor and fan assembly of the ventilation unit are regulated by the control unit.

31. The system of claim 28, wherein the ventilation unit further comprises a humidity sensor which communicates with the control unit, the control unit selectively actuating the ventilation unit and the air exchange unit when the humidity sensor indicates an excess of humidity in an area of the building.

32. The system of claim 28, further comprising a dehumidifying unit including:
a housing having an air inlet and an air outlet located downstream from the air inlet,
a fan and motor assembly mounted on the housing,
a desiccant material mounted in the housing downstream from the housing air inlet for reducing a relative humidity of air flowing through the dehumidifying unit, and
a regenerative heater disposed within the housing adjacent the desiccant material for regenerating the desiccant material.

33. The system of claim 32, wherein the control unit is operably connected to the dehumidifying unit for selectively actuating the dehumidifying unit in order to regulate a rate of air flow through the dehumidifying unit.
